(19) United States
(12) Patent Application Publication
(10) Pub. No.: US 2024/0183218 A1
(43) Pub. Date: Jun. 6, 2024

(54) ANTI-SHRINK WEATHERSTRIP CLIP

(71) Applicant: Andersen Corporation, Bayport, MN (US)

(72) Inventors: Craig Michael Johnson, North Oaks, MN (US); Paul Michael Allan Morris, Roseville, MN (US)

(21) Appl. No.: 18/526,705

(22) Filed: Dec. 1, 2023

Related U.S. Application Data
(60) Provisional application No. 63/429,715, filed on Dec. 2, 2022.

(51) Int. Cl. E06B 7/23

(52) U.S. Cl. CPC E06B 7/2301

(57) ABSTRACT

Embodiments herein relate to fenestration systems and retention clips for securing weatherstrips to fenestration systems. In an embodiment, a fenestration system is included having a structural member defining a weather strip receiving channel. The fenestration system can further include a weather strip configured to fit within the weather strip receiving channel. The fenestration system can further include a retention clip configured to interconnect the weather strip and a surface of the weather strip receiving channel and hold the weather strip in position. Other embodiments are also included herein.

This application claims the benefit of U.S. Provisional Application No. 63/429,715 filed Dec. 2, 2022, the content of which is herein incorporated by reference in its entirety.

### FIELD

Embodiments herein relate to fenestration systems and retention clips for securing weatherstrips to fenestration systems.

### BACKGROUND

Weather stripping is a simple and cost-effective way to reduce the amount of unwanted air, moisture, and debris that enters a home through a fenestration system. Weather stripping works by filling the cracks and gaps around doors and windows to reduce the amount of air leakage and eliminate drafts and cold spots. The benefits of weather stripping include saving money on energy costs, reducing energy usage, increasing comfort, and creating a healthy home environment.

Weatherstrips used in fenestration systems are commonly formed from thermoplastic materials, which generally have large coefficients of thermal expansion. As the weatherstrip undergoes thermal cycling between hot and cold temperatures, stresses within the weatherstrip relax causing the weatherstrip length to shrink. This leads to gaps in the fenestration system which are both visually unappealing and detrimental to the energy efficiency of the fenestration system.

### SUMMARY

Embodiments herein relate to fenestration systems and retention clips for securing weatherstrips to fenestration systems. In a first aspect, a fenestration system is included having a structural member defining a weather strip receiving channel. The fenestration system can further include a weather strip configured to fit within the weather strip receiving channel. The fenestration system can further include a retention clip configured to interconnect the weather strip and a surface of the weather strip receiving channel and hold the weather strip in position.

In a second aspect, in addition to one or more of the preceding or following aspects, or in the alternative to some aspects, the retention clip can be configured to hold the weather strip in position with respect to a lengthwise axis of the weather strip receiving channel.

In a third aspect, in addition to one or more of the preceding or following aspects, or in the alternative to some aspects, the retention clip defines a plurality of teeth.

In a fourth aspect, in addition to one or more of the preceding or following aspects, or in the alternative to some aspects, the plurality of teeth define a corner.

In a fifth aspect, in addition to one or more of the preceding or following aspects, or in the alternative to some aspects, the plurality of teeth can be triangular.

In a sixth aspect, in addition to one or more of the preceding or following aspects, or in the alternative to some aspects, the plurality of teeth alternate extending from opposite sides of the retention clip.

In a seventh aspect, in addition to one or more of the preceding or following aspects, or in the alternative to some aspects, the plurality of teeth can be oriented at an angle relative to a lengthwise axis of the weather strip of 0 to 90 degrees.

In an eighth aspect, in addition to one or more of the preceding or following aspects, or in the alternative to some aspects, the plurality of teeth can be oriented at an angle relative to a lengthwise axis of the weather strip of 0 to 75 degrees.

In a ninth aspect, in addition to one or more of the preceding or following aspects, or in the alternative to some aspects, the retention clip can be positioned at an end of the weather strip receiving channel.

In a tenth aspect, in addition to one or more of the preceding or following aspects, or in the alternative to some aspects, further can include a second retention clip, wherein the second retention clip can be positioned at an opposite end of the weather strip receiving channel.

In an eleventh aspect, in addition to one or more of the preceding or following aspects, or in the alternative to some aspects, the retention clip contacts two opposing surfaces of the weather strip receiving channel.

In a twelfth aspect, in addition to one or more of the preceding or following aspects, or in the alternative to some aspects, the retention clip can include a first side portion and a second side portion. The first side portion and the second side portion can be interconnected at an angle with respect to one another.

In a thirteenth aspect, in addition to one or more of the preceding or following aspects, or in the alternative to some aspects, the first side portion can be taller than the second side portion.

In a fourteenth aspect, in addition to one or more of the preceding or following aspects, or in the alternative to some aspects, the structural member can be a side jamb.

In a fifteenth aspect, in addition to one or more of the preceding or following aspects, or in the alternative to some aspects, the structural member can be a head jamb.

In a sixteenth aspect, in addition to one or more of the preceding or following aspects, or in the alternative to some aspects, the structural member can be a sill.

In a seventeenth aspect, in addition to one or more of the preceding or following aspects, or in the alternative to some aspects, the structural member can be a mull post.

In an eighteenth aspect, in addition to one or more of the preceding or following aspects, or in the alternative to some aspects, the structural member can be an astragal.

In a nineteenth aspect, in addition to one or more of the preceding or following aspects, or in the alternative to some aspects, the structural member can include a pultrusion or an extrusion.

In a twentieth aspect, in addition to one or more of the preceding or following aspects, or in the alternative to some aspects, the weather strip can have a length of at least 8 inches.

In a twenty-first aspect, in addition to one or more of the preceding or following aspects, or in the alternative to some aspects, the weather strip can have a length of at least 48 inches.

In a twenty-second aspect, in addition to one or more of the preceding or following aspects, or in the alternative to some aspects, wherein the retention clip bends at angle of approximately 90 degrees along a lengthwise axis thereof creating a first arm and a second arm. The first arm can be disposed within the weather strip receiving channel and the second arm can be disposed within a second weather strip receiving channel of a second structural member.

In a twenty-third aspect, in addition to one or more of the preceding or following aspects, or in the alternative to some aspects, the weather strip receiving channel can be a non-rectangular channel.

In a twenty-fourth aspect, in addition to one or more of the preceding or following aspects, or in the alternative to some aspects, the weather strip receiving channel can be a kerf.

In a twenty-fifth aspect, in addition to one or more of the preceding or following aspects, or in the alternative to some aspects, the fenestration system can be an entry door system.

In a twenty-sixth aspect, in addition to one or more of the preceding or following aspects, or in the alternative to some aspects, the fenestration system can be a patio door system.

In a twenty-seventh aspect, in addition to one or more of the preceding or following aspects, or in the alternative to some aspects, the fenestration system can be a window system.

In a twenty-eighth aspect, in addition to one or more of the preceding or following aspects, or in the alternative to some aspects, the weather strip can be an active cantilever weather strip.

In a twenty-ninth aspect, in addition to one or more of the preceding or following aspects, or in the alternative to some aspects, the weather strip can be a stationary bulb weather strip.

In a thirtieth aspect, in addition to one or more of the preceding or following aspects, or in the alternative to some aspects, the retention clip can be formed of sheet metal.

In a thirty-first aspect, in addition to one or more of the preceding or following aspects, or in the alternative to some aspects, the retention clip can be formed of stainless steel.

In a thirty-second aspect, in addition to one or more of the preceding or following aspects, or in the alternative to some aspects, the weather strip can be formed of a thermoplastic material.

In a thirty-third aspect, in addition to one or more of the preceding or following aspects, or in the alternative to some aspects, the thermoplastic material can be polypropylene.

In a thirty-fourth aspect, in addition to one or more of the preceding or following aspects, or in the alternative to some aspects, the thermoplastic material can have a coefficient of thermal expansion of about 25×10-6 in/in° F. to 60×10-6 in/in° F.

In a thirty-fifth aspect, in addition to one or more of the preceding or following aspects, or in the alternative to some aspects, the weather strip can include a rigid carrier strip, wherein the rigid carrier strip fits within the retention clip.

In a thirty-sixth aspect, in addition to one or more of the preceding or following aspects, or in the alternative to some aspects, further can include a fastener, wherein the fastener connects the retention clip and the weather strip.

In a thirty-seventh aspect, in addition to one or more of the preceding or following aspects, or in the alternative to some aspects, further can include an adhesive, wherein the adhesive connects the retention clip and the weather strip.

In a thirty-eighth aspect, a method of preventing weather strip shrinkage in a fenestration system can be included. The method can include inserting a retention clip into a weather strip receiving channel of a structural member and inserting a weather strip into the weather strip receiving channel, wherein the retention clip holds the weather strip in the weather strip receiving channel with respect to a lengthwise axis thereof.

In a thirty-ninth aspect, in addition to one or more of the preceding or following aspects, or in the alternative to some aspects, the retention clip defines a plurality of teeth.

In a fortieth aspect, in addition to one or more of the preceding or following aspects, or in the alternative to some aspects, the plurality of teeth alternate extending from opposite sides of the retention clip.

In a forty-first aspect, in addition to one or more of the preceding or following aspects, or in the alternative to some aspects, the plurality of teeth can be oriented at an angle relative to a lengthwise axis of the weather strip of 0 to 90 degrees.

In a forty-second aspect, in addition to one or more of the preceding or following aspects, or in the alternative to some aspects, the plurality of teeth can be oriented at an angle relative to a lengthwise axis of the weather strip of 0 to 75 degrees.

In a forty-third aspect, in addition to one or more of the preceding or following aspects, or in the alternative to some aspects, the retention clip can be inserted at an end of the weather strip receiving channel.

In a forty-fourth aspect, in addition to one or more of the preceding or following aspects, or in the alternative to some aspects, the method can further include inserting a second retention clip into the weather strip receiving channel. The second retention clip can be positioned at an opposite end of the weather strip receiving channel from the retention clip.

In a forty-fifth aspect, in addition to one or more of the preceding or following aspects, or in the alternative to some aspects, the retention clip contacts two opposing surfaces of the weather strip receiving channel.

In a forty-sixth aspect, in addition to one or more of the preceding or following aspects, or in the alternative to some aspects, the retention clip contacts one surface of the weather strip receiving channel.

In a forty-seventh aspect, in addition to one or more of the preceding or following aspects, or in the alternative to some aspects, the structural member can be a side jamb.

In a forty-eighth aspect, in addition to one or more of the preceding or following aspects, or in the alternative to some aspects, the structural member can be a head jamb.

In a forty-ninth aspect, in addition to one or more of the preceding or following aspects, or in the alternative to some aspects, the structural member can be a sill.

In a fiftieth aspect, in addition to one or more of the preceding or following aspects, or in the alternative to some aspects, the structural member can be a mull post.

In a fifty-first aspect, in addition to one or more of the preceding or following aspects, or in the alternative to some aspects, the structural member can be an astragal.

In a fifty-second aspect, in addition to one or more of the preceding or following aspects, or in the alternative to some aspects, the structural member can include a pultrusion or an extrusion.

In a fifty-third aspect, in addition to one or more of the preceding or following aspects, or in the alternative to some aspects, the weather strip can have a length of at least 8 inches.

In a fifty-fourth aspect, in addition to one or more of the preceding or following aspects, or in the alternative to some aspects, the weather strip can have a length of at least 48 inches.

In a fifty-fifth aspect, in addition to one or more of the preceding or following aspects, or in the alternative to some aspects, the weather strip receiving channel can be a non-rectangular channel.

In a fifty-sixth aspect, in addition to one or more of the preceding or following aspects, or in the alternative to some aspects, the weather strip receiving channel can be a kerf.

In a fifty-seventh aspect, in addition to one or more of the preceding or following aspects, or in the alternative to some aspects, the fenestration system can be an entry door system.

In a fifty-eighth aspect, in addition to one or more of the preceding or following aspects, or in the alternative to some aspects, the fenestration system can be a patio door system.

In a fifty-ninth aspect, in addition to one or more of the preceding or following aspects, or in the alternative to some aspects, the fenestration system can be a window system.

In a sixtieth aspect, in addition to one or more of the preceding or following aspects, or in the alternative to some aspects, the weather strip can be an active cantilever weather strip.

In a sixty-first aspect, in addition to one or more of the preceding or following aspects, or in the alternative to some aspects, the weather strip can be a stationary bulb weather strip.

In a sixty-second aspect, in addition to one or more of the preceding or following aspects, or in the alternative to some aspects, the retention clip can be formed of sheet metal.

In a sixty-third aspect, in addition to one or more of the preceding or following aspects, or in the alternative to some aspects, the retention clip can be formed of stainless steel.

In a sixty-fourth aspect, in addition to one or more of the preceding or following aspects, or in the alternative to some aspects, the weather strip can be formed of a thermoplastic material.

In a sixty-fifth aspect, in addition to one or more of the preceding or following aspects, or in the alternative to some aspects, the weather strip can include a rigid carrier strip, wherein the rigid carrier strip fits within the retention clip.

In a sixty-sixth aspect, in addition to one or more of the preceding or following aspects, or in the alternative to some aspects, further can include a fastener, wherein the fastener connects the retention clip and the weather strip.

In a sixty-seventh aspect, in addition to one or more of the preceding or following aspects, or in the alternative to some aspects, further can include an adhesive, wherein the adhesive connects the retention clip and the weather strip.

In a sixty-eighth aspect, in addition to one or more of the preceding or following aspects, or in the alternative to some aspects, the operation of inserting a weather strip into the weather strip receiving channel can be performed after the operation of inserting the retention clip into the weather strip receiving channel of the structural member.

In a sixty-ninth aspect, in addition to one or more of the preceding or following aspects, or in the alternative to some aspects, the operation of inserting a weather strip into the weather strip receiving channel can be performed before the operation of inserting the retention clip into the weather strip receiving channel of the structural member.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a simplified interior side elevation view of a fenestration system in accordance with various embodiments herein.

FIG. 2 is a cross-sectional view of a portion of a fenestration system as taken along line 2-2′ of FIG. 1 in accordance with various embodiments herein.

FIG. 3 is a detailed view of a fenestration system as taken at detail 3 of FIG. 2 in accordance with various embodiments herein.

FIG. 4 is a detailed view of a fenestration system as taken at detail 4 of FIG. 3 in accordance with various embodiments herein.

FIG. 5 is a cross sectional view of a fenestration system in accordance with various embodiments herein.

FIG. 6 is a cross sectional view of a fenestration system in accordance with various embodiments herein.

FIG. 7 is a perspective view of a retention clip in accordance with various embodiments herein.

FIG. 8 is a side view of a retention clip in accordance with various embodiments herein.

FIG. 9 is a perspective view of a retention clip in accordance with various embodiments herein.

FIG. 10 is a detailed view of a tooth taken at detail 10 of FIG. 9 in accordance with various embodiments herein.

FIG. 11 is a schematic view of a structural member in accordance with various embodiments herein.

FIG. 12 is an alternative embodiment of a retention clip in accordance with various embodiments herein.

While embodiments are susceptible to various modifications and alternative forms, specifics thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, weatherstripping typically undergoes thermal cycling between hot and cold temperatures resulting in shrinkage of the weatherstrip in length. This leads to gaps in the fenestration system which are both visually unappealing and detrimental to the energy efficiency of the fenestration system.

However, embodiments herein include the use of retention clips to secure weatherstrips to fenestration systems and reduce or eliminate lengthwise shrinkage of the weatherstrips. As an example, a fenestration system with weather stripping is included herein. The fenestration system can include a door or window framed by a plurality of structural members, such as frame members. One or more of the structural members may define a weather strip receiving channel where a weather strip may be inserted and held in place with respect to a lengthwise axis of the weather strip receiving channel using one or more retention clips.

The retention clip can be inserted into the receiving channel of the structural member and then the weatherstrip can be pressed into the receiving channel and retention clip. However, other orders of operations are also included herein. Regardless, the retention clip acts as an anchor to prevent the weatherstrip from shrinking along the length of the structural member resulting in a tight and gap-free seal between the window or door and the frame members or other structural members.

The retention clip can be of various constructions. In some embodiments, the retention clip can be formed as a thin sheet metal part configured to be snapped into the receiving channel of a structural member. The weatherstrip can then be pressed into the retention clip. The retention clip can include alternating teeth protruding from both directions. The teeth facing the receiving channel anchor the retention clip to the receiving channel of a structural member. When the weatherstrip is inserted into the clip, the teeth facing the weather strip can anchor into a rigid carrier portion of the weatherstrip creating a mechanical attachment of the weatherstrip to the structural member. The mechanical attachment force counteracts the shrink of the weatherstrip resulting in a tight and gap-free seal between the window or door and the structural members.

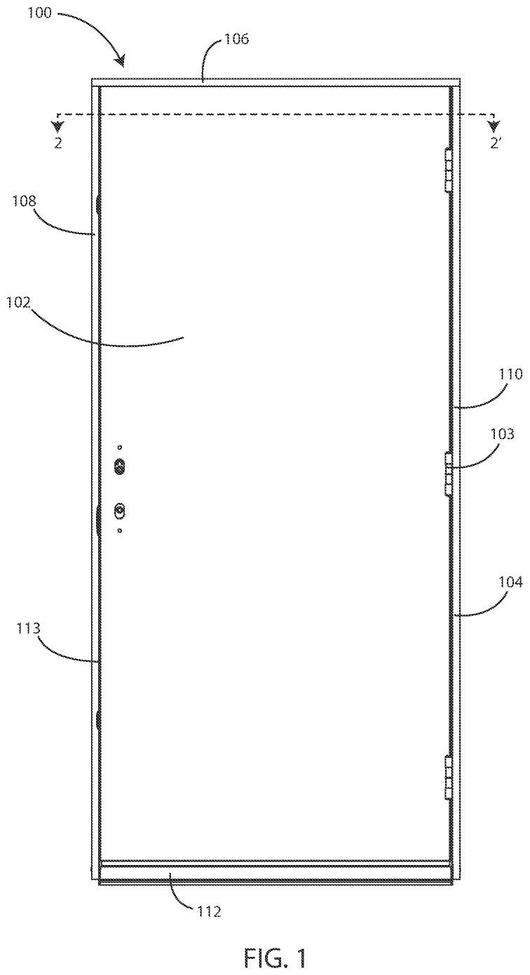

Weather strips and weather strip retention clips herein can be used with various fenestration systems including, but not limited to, entry door systems, patio door systems, windows, and the like. Referring now to FIG. 1, a simplified interior side elevation view is shown of a fenestration system 100 in accordance with various embodiments herein. The fenestration system 100 can include an entry door 102. The framing of the fenestration system 100 can include a plurality of structural members 104 including a head jamb 106, a first side jamb 108, a second side jamb 110, and a sill assembly 112.

The embodiment of FIG. 1 depicts an interior-facing side of the fenestration system 100 with the entry door 102 in a closed position. In various embodiments, the entry door 102 is configured to pivot from an open position to a closed position about one or more hinge members 103. When in the closed position, the outer perimeter of the entry door 102 is configured to be in close proximity with the structural members 104. Ideally, the entry door 102 forms a seal with the structural members 104 to prevent air, moisture, and debris from transferring between the interior and exterior sides of the entry door. However, as the entry door 102 and structural members 104 are formed from rigid materials, (e.g., woods, metals, fiberglass, and the like) a small amount of clearance will typically exist between the entry door and the structural members to allow the entry door to fully close.

To isolate the interior environment more effectively from the exterior environment, weather stripping can be installed around portions of the entry door 102 and/or the structural members 104. Weather stripping can be constructed from a compliant material configured to conform to the entry door 102 and form a seal between the entry door and the structural members 104 when the entry door is in its closed position. In some embodiments, weather stripping is installed such that it extends lengthwise around at least portions of a perimeter 113 defined by the structural members 104. In such cases, when the entry door 102 is in its closed position, it will compress and form a seal with the weather stripping installed in the perimeter 113.

The fenestration system 100 may include weather stripping configured to interface with any or all of the structural members 104 including the head jamb 106, a first side jamb 108, a second side jamb 110, and sill assembly 112. Thus, in some embodiments the weather stripping can be on all side of the perimeter 113 and in other embodiments may only be on certain sides of the perimeter 113. In some embodiments, the weather stripping can be installed as one continuous loop extending all the around the perimeter 113 of the structural members. Alternatively, the fenestration system 100 can include a plurality of discrete weather strips to be installed in one or more of the structural members 104. It will be appreciated that in some embodiments, such as with a transom unit, a sill assembly 112 may be omitted and another jamb member may be used instead. As such, not all sets of structural members for a fenestration include a sill assembly. Further, structural members herein can include components other than frame members. For example, structural members herein can also include mull posts, astragals, and the like.

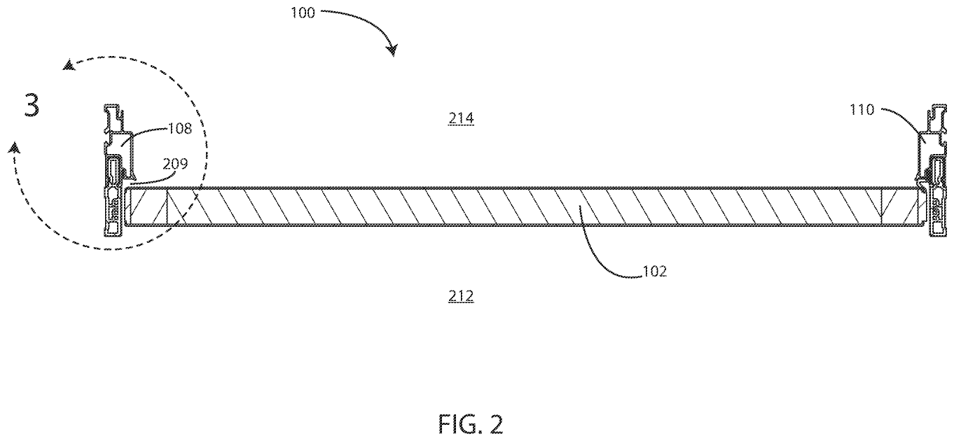

Referring now to FIG. 2, a cross-sectional view of a portion of a fenestration system is shown as taken along line 2-2′ of FIG. 1 in accordance with various embodiments herein. In this example, the fenestration system 100 includes an entry door 102 configured to isolate an interior environment 212 from an exterior environment 214 when the entry door is in its closed position. The entry door 102 is shown in the closed position wherein the left and rightmost ends of the entry door are in close proximity to the first side jamb 108 and the second side jamb 110. In the example of FIG. 2, there is no weather stripping installed for the first side jamb 108, so a clearance 209 exists between the entry door 102 and the first side jamb 108.

In various embodiments, the entry door 102 is configured to pivot counterclockwise from the closed position to an open position about one or more hinge members disposed on the second side jamb 110. In the embodiment of FIG. 2, the entry door would open into the interior environment 212. Alternatively, it is possible for the entry door open outwards into the exterior environment 214. Also, it will be appreciated that hinge members could be disposed on the first side jamb 108. Alternatively, instead of an entry door 102, a stationary panel can be used wherein the panel is compressed against weather stripping on both sides (e.g., between the stationary panel and the first side jamb 108 as well as between the panel and the second side jamb 108) and fixed in position.

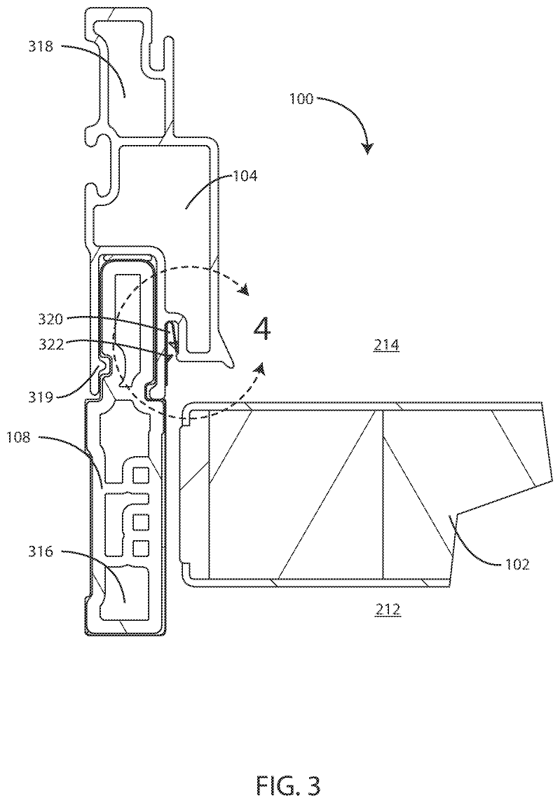

Referring now to FIG. 3, a detailed view of a fenestration system is shown as taken at detail 3 of FIG. 2 in accordance with various embodiments herein. While the embodiment of FIG. 3 depicts the entry door 102 interfacing with the first side jamb 108, aspects of the following description can apply to any structural member 104 of the fenestration system 100. The structural members 104 can be manufactured using any suitable technique or techniques. In some embodiments, the structural member 104 can be formed from a substantially solid material. Alternatively, as depicted in the embodiment of FIG. 3, the structural member can include one or more hollow profiles.

The hollow profiles may be formed using an extrusion or pultrusion process. In the embodiment of FIG. 3, the structural member 104 can include an interior frame portion 316 facing the interior environment 212 and exterior frame portion 318 facing the exterior environment 214 with each frame portion being formed from an extrusion or pultrusion. The interior frame portion 316 and exterior frame portion 318 are connected to each other using one or more mating features 319, such as a friction fit or the like. The structural members 104 can be formed form any suitable material or materials including, but not limited to polymers, metals, woods, composites, or the like. Structural members 104 herein can specifically include, but are not limited to, frame members of fenestration units.

In various embodiments, the structural member 104 can include a weather strip receiving channel 320. In some embodiments, the weather strip receiving channel 320 is a kerf formed by cutting into the structural member 104. Alternatively, the weather strip receiving channel 320 can be formed from one or more profile extrusions, pultrusions, or other suitable techniques. For example, in some embodiments the weather strip receiving channel 320 can be a pultruded non-rectangular channel.

In various embodiments, the weather strip receiving channel is configured to receive a weather strip retention clip 322 and a weather strip (not shown in this view). In the example of FIG. 3, the receiving channel 320 is defined by a pultrusion forming the exterior frame portion 318 with the opening of the receiving channel facing the entry door 102. However, in various embodiments the receiving channel 320 can be defined by a extrusion, pultrusion, hollow or non-hollow member, composite material piece, wood piece, and the like. The receiving channel 320 can be positioned on any suitable location of the structural member 104, such that when a weather strip is inserted into a receiving channel, it will form a seal with the entry door when the entry door is in its closed position. In some embodiments, the receiving channel 320 can include one or more slots or holes that the retention clip(s) 322 can snap into or otherwise be inserted into for additional retention in the receiving channel 320.

It will be appreciated that different sides of the fenestration/frame can have different types of weather stripping (stationary, active, etc.) and/or differently shaped or configured weather stripping (hollow bulbs, foam filled, rectangular, etc.) or the same type, shape, and/or configuration of weather stripping.

In some embodiments, the weather strip receiving channel 320 can span the entire length of the structural member 104. Alternatively, the weather strip receiving channel 320 may span only a portion of the length of the structural member 104. In some embodiments, the weather strip receiving channel 320 may span less than or equal to 100, 90, 80, 70, 60, 50, 40, 30, 20, 10, 5, or 3%, of the length of the structural member 104, or an amount falling within a range between any of the foregoing. In some embodiments, a structural member 104 may include two or more discrete weather strip receiving channels 320. For instance, a structural member may have a first receiving channel 320 at or near a first end of the structural member and a second receiving channel at or near a second end of the structural member.

In some embodiments, all structural members 104 of the fenestration system 100 (e.g., the head jamb 106, first side jamb 108, second side jamb 110, and sill assembly 112) can define a receiving channel 320. Alternatively, only a portion of the structural members of the fenestration system 100 may define a receiving channel 320. For instance, a receiving channel 320 can be defined only in the first side jamb 108 and the second side jamb 110 of the fenestration system 100. Alternatively, a receiving channel 320 can be defined only in the head jamb 106, the first side jamb 108, and the second side jamb 110 of the fenestration system 100. Alternatively, a receiving channel 320 can be defined only in the head jamb 106 and the sill assembly 112 of the fenestration system 100.

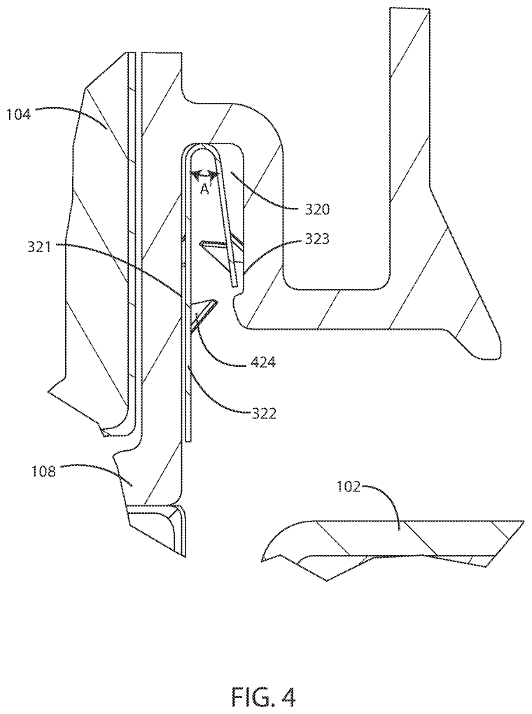

Referring now to FIG. 4, a detailed view of a fenestration system is shown taken at detail 4 of FIG. 3 in accordance with various embodiments herein. In various embodiments, the weather strip receiving channel 320 is configured to receive a weather strip retention clip 322. In some embodiments, the retention clip 322 is configured to contact two opposing surfaces 321, 323 of the receiving channel 320. Alternatively, in some embodiments the retention clip may only contact one of the opposing surfaces 321, 323 of the receiving channel 320.

As will be described in greater detail herein, the retention clip 322 is designed to have sufficient elasticity and/or spring action to be inserted into the receiving channel 320 and return to its original shape. In some approaches, the retention clip 322 is inserted into the into the receiving channel 320 by compressing the two sides of the retention clip together causing it to elastically deform. When the compressive force is released from the retention clip 322, the retention clip can decompress back to its original shape until the sides of the retention clip contact the opposing surfaces 321, 323 of the receiving channel 320. This results in the retention clip exerting a force against the two opposing surfaces 321, 323 of the receiving channels 320, thus holding the retention clip in place with respect to the receiving channel.

In addition to the compressive force exerted by the retention clip 322 on the receiving channel 320, the retention clip can be held in place with respect to the receiving by various additional techniques. In some embodiments, the retention clip 322 defines a plurality of teeth 424. The teeth 424 are configured to engage with, and sometimes at least partially perforate, the two opposing surfaces 321, 323 of the receiving channel 320, preventing the retention clip from slipping with respect to the receiving channel. Additionally, or alternatively, the retention clip 322 and the receiving channel 320 can include one more mating features to hold the retention clip in place within the receiving channel. For instance, the retention clip 322 can define one or more protrusions configured to fit within one or more openings defined in the receiving channel 320. Additionally, or alternatively, the opposing surfaces 321, 323 of the receiving channel 320 and/or the outer surface of the retention clip 322 can be marred or otherwise include a surface texture to increase the friction between the retention clip and the receiving channel.

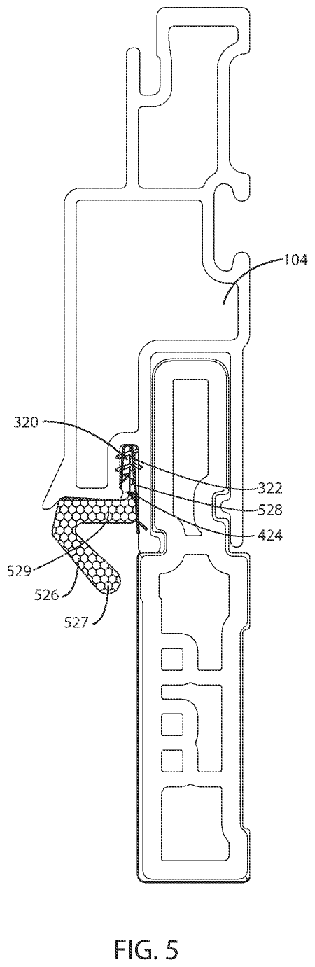

Referring now to FIG. 5, a cross sectional view of a fenestration system is shown in accordance with various embodiments herein. In various embodiments, the fenestration system 100 can include a structural member 104 defining a weather strip receiving channel 320. The fenestration system 100 can further include a weather strip 526 configured to fit within the weather strip receiving channel 320 and a retention clip 322. The retention clip 322 is configured to interconnect the weather strip 526 and a surface of the weather strip receiving channel 320 and hold the weather strip in position. While the embodiment of FIG. 5 shows a generic structural member, it should be noted that the structural member can be any of a head jamb, side jamb, a sill, or other potential structural members. In addition, it will be appreciated that embodiments herein are applicable with any fenestration component (structural or non-structural) that may include weatherstripping such as any component of entry doors, patio doors, windows, and the like. For example, retention clips herein can be used with receiving channels formed in any type of fenestration component to aid in holding weather stripping in position therein. As such, embodiments of fenestration systems herein include the use of retention clips described herein with respect to receiving channels of all types of sashes, panels, jamb members, sills, rails, stiles, panels, and the like that may include weatherstripping.

Weather strip 526 can be formed from any suitable material or materials, such as thermoplastics (e.g., polypropylene or polyethylene) or the like. However, in some cases, the weather strip 526 can be formed, at least in part, using various thermoset polymers. Thermoplastic materials generally have large coefficients of thermal expansion. For example, such materials used herein to form weather strips can have a coefficient of thermal expansion of about 25×10⁻⁶ in/in° F. to 60×10⁻⁶ in/in° F. When installed in an external environment, thermoplastic weather strips can shrink up to 5% of their length as the weatherstrip undergoes thermal cycling between hot and cold temperatures. However, by retaining the weather strip in the receiving channel with a retention clip herein, such undesirable shrinkage can be avoided.

In some embodiments, a retention clip 322 is first placed into the receiving channel 320 of the structural member 104. After inserting the retention clip 322, a first portion 528 of the weather strip 526 is inserted into the receiving channel 320 and is positioned between the two opposing sides of the retention clip 322. Alternatively, a first portion 528 of the weather strip 526 is first inserted into contact with the retention clip 322 and then the combined retention clip and weather strip are inserted into the weather strip receiving channel 320 of the structural member 104.

In some embodiments, first portion 528 of the weather strip 526 is formed form the same thermoplastic material as the reminder of the body strip. Alternatively, first portion 528 of the weather strip 526 may include a rigid carrier strip that is configured to fit within the retention clip. The rigid carrier strip can be formed of a polymeric material exhibiting different properties than the other portion(s) of the weather strip 526. In some embodiments, the rigid carrier strip can be formed of a polymeric material that is less flexible than the other portion(s) of the weather strip 526. The rigid carrier strip can be formed of various polymers including various thermoplastics and thermosets.

The retention clip 322 is configured to hold the weather strip in position with respect to a lengthwise axis (an axis perpendicular to the cross section of FIG. 5) of the weather strip receiving channel 320 by any suitable means. In various embodiments, a plurality of teeth 424 disposed on retention clip 322 are configured to engage with (and sometimes perforate) the first portion 528 of the weather strip 526, thus anchoring the weather strip to the retention clip 322. The retention clip 322 holds the weather strip in place with respect to a lengthwise axis of the weather strip receiving channel (an axis perpendicular to the cross section). It will be appreciated that the retention clip 322 can also hold the weather strip 526 in place in the weather strip receiving channel 320 with respect to a direction perpendicular to the lengthwise axis of the weatherstrip receiving channel 320, thus holding the weather strip 526 in the weatherstrip receiving channel 320.

Additionally, or alternatively, the fenestration system 100 can include one or more fasteners configured to fix the weather strip 526 to the retention clip 322. In one example, the retention clip 322 may define one or more openings or apertures on each of its opposing sides that are sized to receive a fastener (a screw, a rivet, a nail, a bolt, a pin, etc.). The first portion 528 of the weather strip 526 can be inserted between the two sides of the retention clip 322 and the fastener can be inserted through the opposing holes of the retention clip and pierce the first portion of the weather strip, thus fixing the weather strip to the retention clip.

Additionally, or alternatively, an adhesive can be applied to the weather strip 526 and/or the retention clip 322, such that when the first portion 528 of the weather strip is inserted into the retention clip, the weather strip is adhered to one or both of the opposing sides of the retention clip, thus fixing the weather strip to the retention clip.

Additionally, or alternatively, the retention clip 322 may be riveted and/or crimped. The riveted or crimped portions of the retention clip 322 are configured to engage with (and sometime perforate) the first portion 528 of the weather strip 526, thus fixing the weather strip to the retention clip. The combination of any of the above fixing means creates a mechanical attachment force between the weather strip 526 and the retention clip 322 (which is not subject to shrinking), which counteracts the tendency of the weather strip to shrink during thermal cycling.

The weather strip 526 can be any suitable type of weather strip. The weather strip 526 depicted in FIG. 5 is an active cantilever weather strip. The active cantilever weather strip 526 can include a cantilever portion 527 and a stationary portion 529. The cantilever portion 527 is supported on a single end and is configured to deflect towards the stationary portion 529 when the entry door 102 is in its closed potion. The cantilever portion 527 and the stationary portion 529 of the active cantilever weather strip 526 are both configured to compress and form a seal with the entry door 102 when the entry door is in its closed position.

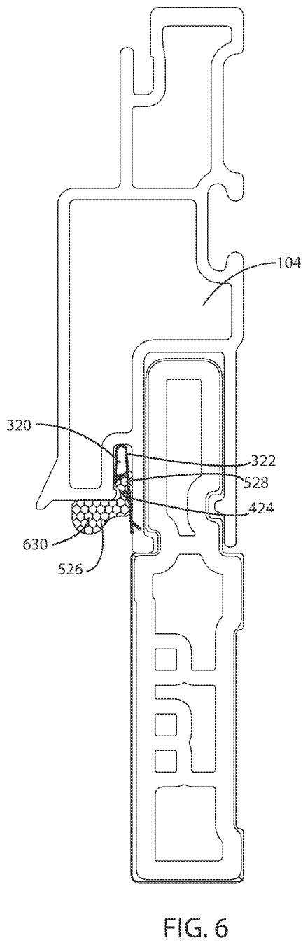

Other types of weather strips can also be used in the fenestration system 100. Referring now to FIG. 6, a cross sectional view of a fenestration system is shown in accordance with various embodiments herein. In various embodiments, the fenestration system 100 can include a structural member 104 defining a weather strip receiving channel 320, a weather strip 526, and a retention clip 322.

The configuration of FIG. 6 is substantially similar to that of FIG. 5, but the weather strip 526 is a stationary bulb type weather strip. A stationary bulb weather strip utilizes a bulb portion 630 to seal a door or compartment. Unlike the active cantilever weather strip, the stationary bulb does not deflect, but is configured to compress and form a seal with the entry door 102 when the entry door is in its closed position. Other types of weather strips can be used in the fenestration system 100 including, but not limited to, various other types of compression, deflection, and/or contact based weather strips.

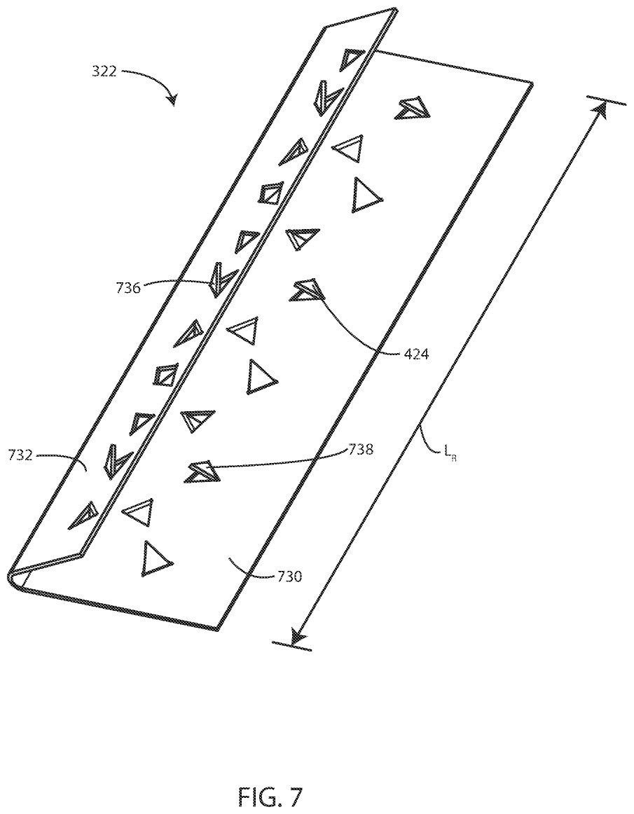

FIGS. 7-9 show a retention clip in accordance with various embodiments herein. For example, FIG. 7 shows a perspective view of a retention clip in accordance with various embodiments herein. The retention clip 322 can be formed from any suitable material or materials that give it sufficient elasticity and yield strength such that the retention clip can be compressed to fit within the receiving channel 320 and return to its original shape. The retention clip 322 can be formed of a material that does not exhibit any substantial shrinkage in response to thermal cycling. In some embodiments, the retention clip is formed from a sheet metal such as stainless steel, spring steel, aluminum, or other metals or alloys, or the like. Alternatively, the retention clip can be an injection molded part formed from one or more polymeric materials.

The retention clip can have a length L_{R}. In some embodiments, the length L_{R} can be greater than or equal to 1, 2, or 4 in. In some embodiments, the length L_{R} can be less than or equal to 24, 12, 8, 4, or 2 in. In some embodiments, the length L_{R} can fall within a range of 1.0 to 12.0 in, or 1 to 6 in, or 1 to 3 in, or can be about 2 in. The retention clip length L_{R} can vary as a function of the size of the receiving channel, structural member, and/or entry door.

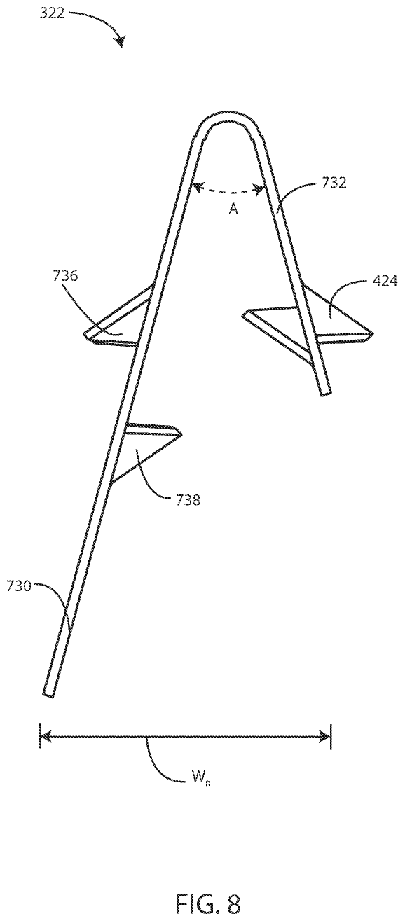

As seen in FIG. 8, the retention clip 322 can have a width W_{R}. In some embodiments, the width W_{R} can be greater than or equal to 0.1, 0.15, 0.2, or 0.25 in. In some embodiments, the width W_{R} can be less than or equal to 1, 0.5, 0.4, 0.35, 0.3, or 0.25 in. In some embodiments, the width W_{R} can fall within a range of 0.15 to 1 in, or 0.25 to 0.75 in, or 0.2 to 0.3 in, or can be about 0.25 in. The width W_{R} can vary as a function of the size of the receiving channel, structural member, and/or entry door.

In various embodiments, the retention clip 322 can include a first side portion 730 and a second side portion 732. In some embodiments, the first side portion 730 is longer than the second side portion 732. Alternatively, the first side portion 730 and second side portion 732 can be substantially the same length. The relative lengths of the first side portion 730 and the second side portion 732 can vary as a function of the geometry of the receiving channel 320. In the examples of FIGS. 4-6, the first side portion 730 of the retention clip 322 rests against the longer opposed surface 321 of the receiving channel 320 and second side portion 732 of the retention clip rests against the shorter opposed surface 323 of the receiving channel.

In various embodiments, the first side portion 730 and the second side portion 732 of retention clip 322 are interconnected at an angle A with respect to one another. In some embodiments, the angle A can be greater than or equal to 15, 20, 25, or 30 degrees. In some embodiments, the angle A can be less than or equal to 45, 40, 35, or 30 degrees. In some embodiments, the angle A can fall within a range of 15 to 45 degrees, or 20 to 40 degrees, or 25 to 35 degrees, or can be about 30 degrees.

In some embodiments, the retention clip 322 may lack both a first side portion and a second side portion. For example, the retention clip 322 can take the form of a one-sided plate with teeth or spurs. Such an embodiment can allow the weatherstrip to be inserted into the receiving channel first followed by inserting the one-sided clip or plate.

Referring back to FIG. 4, in various embodiments the side portions of the retention claim 322 are compressed when the retention clip is inserted into the receiving channel 320. Consequentially, the angle A connecting the two side portions is reduced to a compressed angle A′. In some embodiments, the angle A′ can be greater than or equal to 5, 7, 8, or 10 degrees. In some embodiments, the angle A′ can be less than or equal to 20, 17, 13, or 10 degrees. In some embodiments, the angle A′ can fall within a range of 5 to 20 degrees, or 7 to 17 degrees, or 8 to 13 degrees, or can be about 10 degrees. As can be seen in FIG. 7, the retention clip 322 can define a plurality of teeth 424 or spurs or pointed projections. The retention clip 322 can have one or more external teeth 736 projecting externally outward from the retention clip. The external teeth 736 are configured to hold the retention clip 322 in place with respect to the receiving channel 320. The retention clip can also have one or more internal teeth 738 projecting internally inward from the retention clip. The internal teeth 738 are configured to hold the weather strip 526 in place with respect to the retention clip 322. In some embodiments, the retention clip 322 can have a combination of external teeth 736 and internal teeth 738. In the example of FIGS. 7-9, the retention clip 322 has a pattern of alternating external teeth 736 and internal teeth 738, but other configurations of teeth are also contemplated herein.

In the example of FIGS. 7-9, all of the teeth 424 on the retention clip 322 are substantially the same shape and size. Alternatively, a retention clip 322 may have a plurality of teeth 424 of varying sizes. In one example, all the external teeth 736 may be of a first size and all the internal teeth 738 may be of a second size. The first size may be smaller or larger than the second size. It is also conceivable for the retention clip 322 to have a plurality of teeth 424 of varying shapes. In some embodiments, the plurality of teeth 424 can all be substantially triangular but have different aspect ratios. The teeth 424 may also be of any other suitable shape configured to grip the receiving channel 320 and weather strip 526. In some embodiments, the teeth 424 can be substantially square or rectangular. In some embodiments, the teeth 424 can include at least one sharp corner that projects outward from the surface of the retention clip 322.

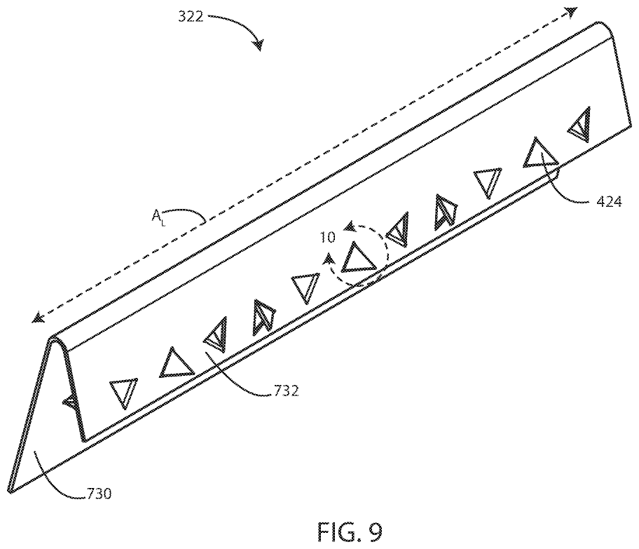

In the example of FIG. 9, the plurality of teeth 424 are oriented such that the point of each tooth (or the lengthwise axis of the tooth) forms an angle (θ₁) relative to a lengthwise axis A_{L} of the weather strip 526. In some embodiments, the plurality of teeth 424 are all oriented at the same angle relative to the lengthwise axis A_{L} of the weather strip 526. Alternatively, the plurality of teeth 424 can be oriented at different angles relative to the lengthwise axis A_{L} of the weather strip 526. In the embodiment of FIGS. 7-9, the plurality of teeth 424 can be oriented with the point of the teeth 424 forming angles relative to the lengthwise axis A_{L} of the weather strip 526 ranging from 0 to 75 degrees. In some embodiments, the teeth 424 can be oriented at angles ranging from 0 to 90 degrees, such as in the context of relatively softer structural member materials such as wood structural members.

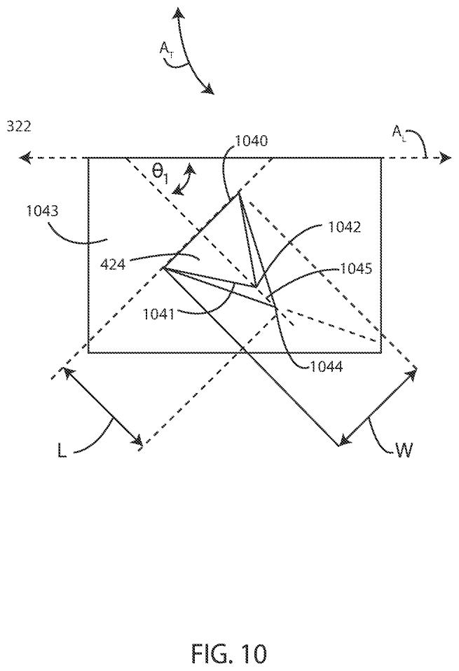

Referring now to FIG. 10 a detailed view of a tooth taken at detail 10 of FIG. 9 is shown in accordance with various embodiments herein. While FIG. 9 depicts an exemplary body of a single tooth 424 the following disclosure may apply to any tooth on the retention clip 322.

As before, the retention clip 322 can define a plurality of teeth 424. In various embodiments, each tooth can be formed by making cuts in the main body portion 1043 of retention clip 322. In the example of FIG. 10, each tooth 424 is substantially triangular in profile and has a base 1040 defined in a main body portion 1043 of retention clip 322. To form each tooth 424, two cuts 1041 are made in the main body portion 1043 of retention clip 322. The two cuts 1041 converge at an apex 1042 which forms the tip of the triangular tooth 424. The tooth 424 can then be pushed out from the main body portion 1043 of retention clip 322 such that the tooth hinges at its base 1040 and the apex 1042 projects either outward from the main body to form an external tooth 736 or inward from the main body to form an internal tooth 738. This leaves a void 1045 on the main body portion 1043 of retention clip 322 for each tooth 424. Other shapes of teeth are contemplated herein and can be formed based on the cuts made in the main body portion 1043 of retention clip 322. The tooth 424 may any suitable shape configured to grip the receiving channel 320 and weather strip 526.

The teeth 424 may be formed on the retention clip 322 in a number of different alternative ways. In one example, where the retention clip 322 is an injection molded part and the teeth 424 can be injection molded along with the retention clip. In another example, where the retention clip 322 is a metallic part and a plurality of teeth 424 can be mechanically joined to the retention clip by means of welding, soldering, or the like.

Each tooth 424 can have a width W defined herein as the width of the base 1040. In some embodiments, the tooth width W can be greater than or equal to 1.5, 1.7, 1.8, or 2.0 mm. In some embodiments, the tooth width W can be less than or equal to 2.5, 2.3, 2.2, or 2.0 mm. In some embodiments, the tooth width W can fall within a range of 1.5 to 2.5 mm, or 1.7 to 2.3 mm, or 1.8 to 2.2 mm, or can be about 2.0 mm.

Each tooth 424 can have a length L defined as the shortest distance between the base 1040 of the tooth and the apex 1044 of the void 1045 left by the tooth in the retention clip main body portion 1043. The tooth length L can be greater than or equal to 1.5, 1.7, 1.8, or 2.0 mm. In some embodiments, the tooth length L can be less than or equal to 2.5, 2.3, 2.2, or 2.0 mm. In some embodiments, the tooth length L can fall within a range of 1.5 to 2.5 mm, or 1.7 to 2.3 mm, or 1.8 to 2.2 mm, or can be about 2.0 mm.

Each tooth 424 can have a tooth angle A_{T} defined as the angle between the base 1040 and the lengthwise axis of the retention clip L. In some embodiments, the tooth angle A_{T} can be greater than or equal to 0, 15, 30, or 45 degrees. In some embodiments, the tooth angle A_{T} can be less than or equal to 75, 65, 55, or 45 degrees. In some embodiments, the tooth angle A_{T} can fall within a range of 0 to 75 degrees, or 15 to 65 degrees, or 30 to 55 degrees, or can be about 45 degrees. In some embodiments, all the teeth 424 on a retention clip 322 have the same tooth angle A_{T}. Alternatively, the plurality of teeth 424 on a retention clip 322 may have random or alternating tooth angles.

Additionally, or alternatively to having a plurality of teeth 424, and as detailed above, the retention clip 322 can also include one or more of rivets, crimps, other fasteners, or adhesives to hold the retention clip in the receiving channel 320 and to hold the weather strip 526 to the retention clip.

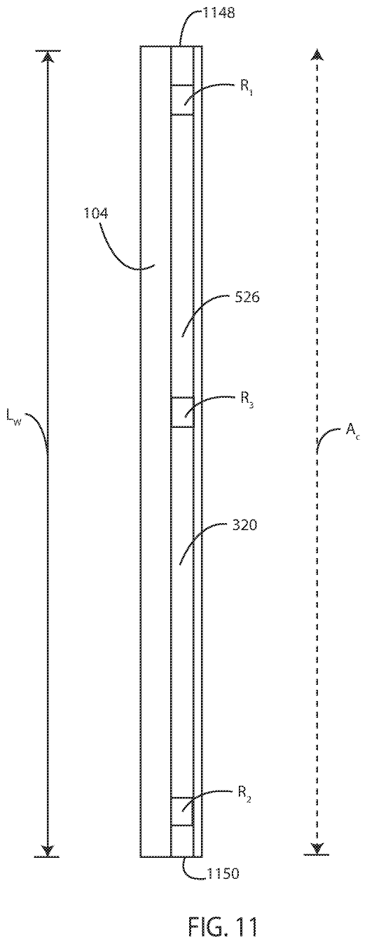

Referring now to FIG. 11 a schematic view of a structural member is shown in accordance with various embodiments herein. The structural member can have a weather strip 526 disposed within a receiving channel 320 on the structural member. The weather strip 526 can have a weather strip length L_{W}. In some embodiments, the weather strip length L_{W} can be greater than or equal to 1, 2, 5, 8, 10, 15, 20, 25, 30, 35, 40, 45, 50, 55, or 60 inches, or can be an amount falling within a range between any of the foregoing. Issues of shrinkage can be more substantial the longer the weather strip is. In some embodiments, the weather strip has a length of at least 8 inches. In some embodiments, the weather strip has a length of at least 48 inches.

In the embodiment of FIG. 11, weather strip 526 spans the entire length of the structural member 104. Alternatively, the weather strip 526 may span only a portion of the length of the structural member 104 or may span two or more discrete portions of the frame member.

The weather strip 526 can be inserted into the receiving channel 320 of the structural member 104 as described in detail above. In various embodiments, the weather strip 526 is secured to the receiving channel 320 with one or more retention clips 322. The one or more retention clips 322 are configured to hold the weather strip 526 in position with respect to a lengthwise axis A_{C} of the weather strip receiving channel 320.

The retention clips 322 can be inserted into the receiving channel 320 at various attachments points R₁-Rₙ along lengthwise axis A_{C} of the weather strip receiving channel. In some embodiments, a retention clip 322 is positioned at or near an end of the weather strip receiving channel 320. In some embodiments, a second retention clip 322 can be positioned at or near an opposite end of the weather strip receiving channel 320. In some embodiments, multiple retention clips can be used spaced out along the weather strip receiving channel 320. As such, one, two, three, four, five, six or more retention clips can be used for each weather strip receiving channel.

The example of FIG. 11 shows a first attachment point R₁ for the attachment of a first retention clip 322 at or near a first end 1148 of the receiving channel 320, second attachment point R₂ for the attachment of a second retention clip at or near a second end 1150 of the receiving channel, and a third attachment point R₃ for the attachment of a third retention clip at near the center of the receiving channel. Any suitable number and/or configuration of attachment points can be used to secure a weather strip 526 to a structural member 104.

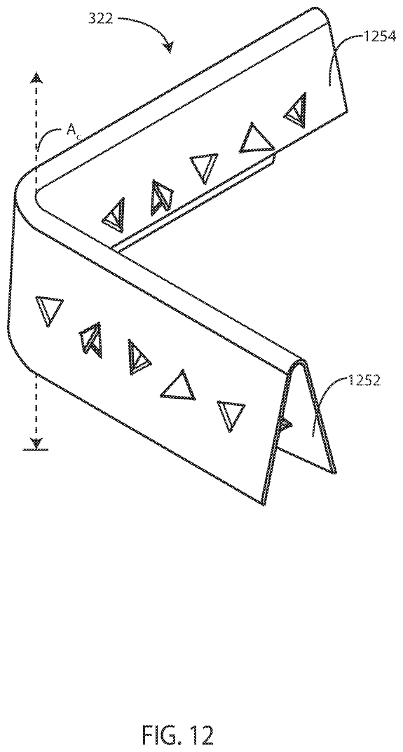

Referring now to FIG. 12 an alternative embodiment of a retention clip is shown in accordance with various embodiments herein. FIG. 12 depicts a retention clip 322 that has been bent at angle of approximately 90 degrees along a central axis A_{C} creating a first arm 1252 and a second arm 1254. The first arm 1252 may disposed within the weather strip receiving channel 320 of a first structural member. The first arm is configured to hold a first weather strip (or first weather strip side) in position with respect to a lengthwise axis of the receiving channel of the first structural member. The second arm 1254 may disposed within the weather strip receiving channel 320 of a second structural member. The second arm 1254 is configured to hold a second weather strip (or second weather strip side) in position with respect to a lengthwise axis of the receiving channel of the second structural member. The first and second fame members can be any two structural members that are located perpendicular and adjacent to one another in a fenestration system.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A fenestration system comprising:
a structural member, the structural member defining a weather strip receiving channel;
a weather strip, wherein the weather strip is configured to fit within the weather strip receiving channel; and
a retention clip, wherein the retention clip is configured to interconnect the weather strip and a surface of the weather strip receiving channel and hold the weather strip in position.

2. The fenestration system of claim 1, wherein the retention clip is configured to hold the weather strip in position with respect to a lengthwise axis of the weather strip receiving channel.

3. The fenestration system of claim 1, the retention clip defining a plurality of teeth.

4. The fenestration system of claim 3, wherein the plurality of teeth define a corner.

5. The fenestration system of claim 3, wherein the plurality of teeth are triangular.

6. The fenestration system of claim 5, wherein the plurality of teeth alternate extending from opposite sides of the retention clip.

7. The fenestration system of claim 3, wherein the plurality of teeth are oriented at an angle relative to a lengthwise axis of the weather strip of 0 to 90 degrees.

8. The fenestration system of claim 3, wherein the plurality of teeth are oriented at an angle relative to a lengthwise axis of the weather strip of 0 to 75 degrees.

9. The fenestration system of claim 1, wherein the retention clip is positioned at an end of the weather strip receiving channel.

10. The fenestration system of claim 9, further comprising a second retention clip, wherein the second retention clip is positioned at an opposite end of the weather strip receiving channel.

11. The fenestration system of claim 1, wherein the retention clip contacts two opposing surfaces of the weather strip receiving channel.

12. The fenestration system of claim 1, the retention clip comprising:
a first side portion; and
a second side portion, wherein the first side portion and the second side portion are interconnected at an angle with respect to one another.

13. The fenestration system of claim 12, wherein the first side portion is taller than the second side portion.

14. The fenestration system of claim 1, wherein the structural member comprises at least one of a side jamb, a head jamb, a sill, a mull post, and an astragal.

15-23. (canceled)

24. The fenestration system of claim 1, wherein the weather strip receiving channel is a kerf.

25-29. (canceled)

30. The fenestration system of claim 1, wherein the retention clip is formed of sheet metal.

31. The fenestration system of claim 1, wherein the retention clip is formed of stainless steel.

32. The fenestration system of claim 1, wherein the weather strip is formed of a thermoplastic material.

33. (canceled)

34. The fenestration system of claim 32, wherein the thermoplastic material has a coefficient of thermal expansion of about 25×10-6 in/in° F. to 60×10-6 in/in° F.

35. The fenestration system of claim 1, the weather strip comprising a rigid carrier strip, wherein the rigid carrier strip fits within the retention clip.

36-69. (canceled)
